(19) United States
(12) Patent Application Publication
(10) Pub. No.: US 2014/0295151 A1
(43) Pub. Date: Oct. 2, 2014

(54) PRINT SHEET AND MULTIFUNCTIONAL PROJECTION SCREEN USING SAME

(71) Applicants: Osamu Gotou, Saitama (JP); Tomomichi Dougase, Saitama (JP); Yuuichi Isemori, Tokyo (JP)

(72) Inventors: Osamu Gotou, Saitama (JP); Tomomichi Dougase, Saitama (JP); Yuuichi Isemori, Tokyo (JP)

(21) Appl. No.: 14/347,648

(22) PCT Filed: Feb. 15, 2012
(86) PCT No.: PCT/JP2012/053580

§ 371 Date: May 14, 2014

(30) Foreign Application Priority Data
Sep. 28, 2011 (JP) 2011-213475
Dec. 20, 2011 (JP) 2011-278248

(51) Int. Cl. G03B 21/60

(52) U.S. Cl. CPC G03B 21/60
USPC 428/201

(57) ABSTRACT

The invention provides a print sheet and a multifunctional projection screen using the print sheet, wherein the print sheet comprises, on a substrate, sequentially a precoat layer, a dot-printed layer, an easily adhesive layer, and a surface protective layer comprising a crosslink-hardened material of a hardening resin composition; and the precoat layer comprises a resin composition comprising titanium oxide and at least one resin selected from a polyurethane resin and an acryl polyol resin. The print sheet can be obtained by using a gravure printing method having outstanding production efficiency; and in addition, it has a dot pattern readable with high reading precision by a prescribed dot size (dot diameter in the range of 80 to 130 μm).

### TECHNICAL FIELD

Present invention relates to a print sheet and a multifunctional projection screen using the print sheet, wherein the print sheet is used in a device to which a hand-written information enters thereby transforming a hand-written figure to a digital information, and is used by adhering on surface of a medium to be written.

### BACKGROUND ART

In recent years, a need to transform a hand-written word, figure, symbol, and so forth to electronic data that can be dealt by an information-processing device is increasing; especially a demand on a method with which a hand-written information is entered into a computer and the like in real-time without going through a reading device such as a scanner is increasing.

For example, in Patent Document 1, a transparent sheet arranged in front of a display device, especially, a transparent sheet printed with a dot pattern which is capable of providing location information to show the location of an input trajectory by an electronic input pen and so forth, is disclosed. This transparent sheet has the dot pattern printed by using an ink emitting the light that can be read by irradiating a light having a prescribed wavelength thereby having a function to provide location information by an input trajectory reading means. However, in Patent Document 1, there is no description as to a kind of the ink that can realize the transparent sheet like this, a direction of the printed surface, a way how to lay out the location information, or the like, so that there is no description as to the specific example of the transparent sheet; and thus, the description thereof is merely an idea or a desire of the transparent sheet.

On the other hand, a proposal was made about a transparent sheet printed with an infrared reflective pattern that can provide an information with regard to location of the input terminal on the transparent sheet, wherein the transparent sheet has a printed surface having a transparent pattern with an infrared light reflective regularity printed on surface of a transparent substrate, and this is installed in front of a display device capable of image-displaying such that the said printed surface may face to the device; the ink to constitute the transparent pattern contains an infrared-reflective material; and the transparent pattern is irradiated with an infrared light from the backside of the printed surface by using an input terminal capable of irradiation and detection of the infrared light thereby reading the reflection pattern of the infrared light (see, Patent Document 2).

In addition, an electronic pen-writing paper is proposed, wherein the electronic pen-writing paper is used for a data-input system to transmit a dot pattern from a transmitting unit to an outside communication device, the said dot pattern printed around the place where an electronic pen is put on being read by a sensing unit that is built-in the electronic pen when an information is written on an information-writing surface by the electronic pen; and if a figure pattern other than the dot pattern is printed on the information-writing surface is printed, the dot pattern is printed firstly, and on it is printed the figure pattern (see, Patent Document 3).

Further, a print sheet is proposed, wherein the print sheet is a laminate having a substrate, a regular pattern-printed layer, an easily adhesive layer, and a surface protective layer in this order; an ink to constitute the printed layer contains a colorant; the printed layer can provide an information with regard to location of the input terminal on the print sheet by reading the pattern from the side of the surface protective layer by using a pattern-detectable input terminal; the surface protective layer is a hardened filler-containing hardening resin composition; and the 60 degree gloss value is in the range of 8 to 20 (see, Patent Document 4).

The pattern-printed transparent sheet disclosed in Patent Document 2 is used by installing in front of a display; and the electronic pen-writing paper disclosed in Patent Document 3 is used as an input pad.

During the time of a lecture, a conference, and so forth, in order to make them interactive, it may be sometimes necessary to project a hand-written word, figure, symbol, and the like on a projection screen through a projector or the like after these informations are transformed to electronic data. In addition, it would be very useful if it is possible to project a document, which is directly written in the projected figure on a projection screen, through a projector after it is taken-in in real-time as digital information.

On the other hand, in the case that it is not necessary to make the conference interactive such as those mentioned above, for example, in the case of brainstorming, the projection screen may be used effectively as a writing board like a white board.

The equipment having many functions aggregated as a projection screen and a white board as mentioned above is very useful not only because various uses may be covered by single equipment but also because a space in a conference room may be conserved.

However, practically it is not an easy task to simultaneously satisfy the functions as a projection screen and a white board without impairing the functions as a print sheet.

Accordingly, the projection screen using the print sheet disclosed in Patent Document 4 was revolutionary because it had the function as a white board simultaneously.
Patent Document 1: Japanese Patent Laid-Open Publication No. 2003-256122
Patent Document 2: Japanese Patent Laid-Open Publication No. 2008-26958
Patent Document 3: Japanese Patent Laid-Open Publication No. 2008-173859
Patent Document 4: Japanese Patent Laid-Open Publication No. 2011-95706

### PROBLEMS TO BE SOLVED BY THE INVENTION

Inventors of the present invention carried out an extensive study about the method for printing a dot pattern on a substrate of the print sheet mentioned above; and as a result, it was found that a gravure printing method was desirable because of fast printing speed and high productivity; but it was also found that to obtain a dot pattern readable with high reading precision was difficult by a prescribed dot size (dot diameter in the range of 80 to 130 μm) by means of a gravure printing method.

On the other hand, printing of the dot pattern by a digital printing method such as an ink jet printing method is prone to give a more precise dot size as compared with the gravure printing method; however, it was finally recognized that to make it a highly practical method was difficult because of slow printing speed and poor productivity.

In view of the situation as mentioned above, an object of the present invention is to provide a print sheet and a multifunctional projection screen using this print sheet, wherein the said print sheet not only can be obtained by using the gravure printing method having outstanding production efficiency in printing of the dot pattern but also has a dot pattern readable with high reading precision by a prescribed dot size (dot diameter in the range of 80 to 130 μm).

### Means for Solving the Problems

Inventors of the present invention carried out an extensive investigation to solve the problems mentioned above; and as a result, it was found that the problems could be solved by interposing a specific precoat layer between the substrate and the dot-printed layer. The present invention was completed based on this information.

That is, the present invention provides a print sheet and a multifunctional screen using this print sheet, wherein the print sheet comprises, on a substrate, sequentially a precoat layer, a dot-printed layer, an easily adhesive layer, and a surface protective layer comprising a crosslink-hardened material of a hardening resin composition; and the precoat layer comprises a resin composition comprising titanium oxide and at least one resin selected from a polyurethane resin and an acryl polyol resin.

The print sheet of the present invention can be obtained by using a gravure printing method having outstanding production efficiency for printing of the dot pattern; and in addition, it has a dot pattern readable with high reading precision by a prescribed dot size (dot diameter in the range of 80 to 130 μm) whereby providing a precise location information. In addition, the projection screen using this print sheet has: a function to project the data of words and figures through a projector or the like, while writing can be done thereon; a function to take-in the said written information in real-time as a highly precise digital information; and at the same time, a function as a white board having outstanding surface scratch resistance.

### BRIEF DESCRIPTION OF THE DRAWING

FIG. 1

This is a conceptual diagram showing a cross section of one embodiment of the print sheet of the present invention.

### MODES FOR CARRYING OUT THE INVENTION

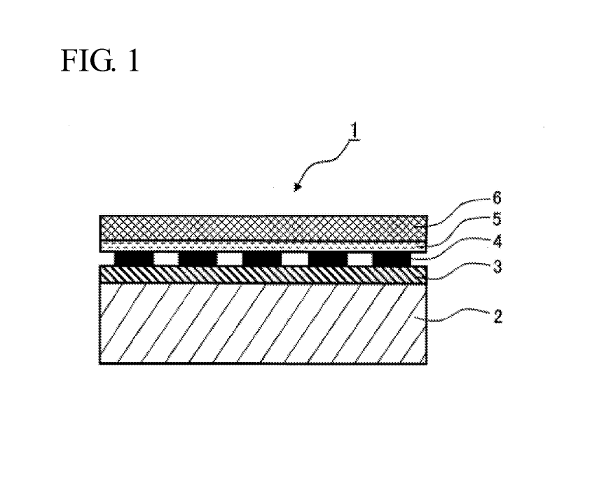

The configuration of the print sheet of the present invention will be explained hereunder in detail by using FIG. 1.

The print sheet 1 of the present invention has, on the substrate 2, sequentially the precoat layer 3, the dot-printed layer 4, the easily adhesive layer 5, and the surface protective layer 6 comprising a crosslink-hardened material of a hardening resin composition.

In the print sheet of the present invention, in order to obtain both functions as a projection screen and a mark-erasing ability on the sheet surface, the 60 degree gloss value is preferably in the range of 10 to 75; or in view of the mark-erasing ability as an important characteristic thereof, more preferably in the range of 25 to 75.

As to the substrate 2 in the present invention, there is no particular restriction provided it is used as a usual print sheet; generally, a plastic film can be suitably used. As the plastic film, films of various synthetic resins may be mentioned. Illustrative example of the synthetic resin includes polyolefin resins such as polyethylene, polypropylene, poly(methyl pentene), and olefin-based thermoplastic elastomer; vinyl resins such as polyvinyl chloride, polyvinylidene chloride, and ethylene-vinyl alcohol copolymer; polyester resins such as polyethylene terephthalate, polybutylene terephthalate, polyethylene naphthalate, and polyester-based thermoplastic elastomer; acryl resins such as poly[methyl(meth)acrylate], poly[ethyl(meth)acrylate], and poly[butyl(meth)acrylate]; polyamide resins represented by nylon 6, nylon 66, and the like; triacetate cellulose resin, cellophane; polystyrene; polycarbonate resin; and polyarylate resin.

Among them, polyester resins are preferable because these resins have a certain level of strength that is required in order to protect a pattern (this will be mentioned later) against a thermal shock and a physical impact. Illustrative example of the polyester resin includes polyarylate, polycarbonate, ethylene terephthalate-isophthalate copolymer, and polyarylate, in addition to polyethylene terephthalate (hereinafter, this is sometimes referred to as “PET”), polybutylene terephthalate, and polyethylene naphthalate. Among them, polyethylene terephthalate and polybutylene terephthalate are preferable, while polyethylene terephthalate is especially preferable because of easy handling and low cost.

Thickness of the substrate 2 is not particularly restricted and may be set arbitrarily in accordance with the product characteristics; however, thickness is preferably in the range of 25 to 400 μM. This range is preferable, because a concavity is not readily formed by a pen pressure when writing is made by a pen tip such as a hard tip of an electronic pen as an input terminal (this will be mentioned later). In addition, this range is preferable because of outstanding workability during the time of lamination thereof with a substrate such as a steel plate and a magnet sheet. From the above view points, thickness of the substrate 2 is more preferably in the range of 75 to 250 μm.

In addition, in the synthetic resin used in the substrate 2, an additive may be added as necessary. Illustrative example of the additive includes a filler, a flame retardant, an antioxidant, a sliding agent, a blowing agent, a UV absorber, and a light-stabilizer.

Meanwhile, the print sheet 1 of the present invention may be used for various applications; however, if it is used as a white board and a projection screen, which are most favorable uses thereof, color of the substrate 2 is preferably white; and therefore, it is preferable that colorants such as calcium carbonate, titanium oxide, mica, talc, and the like be added therein.

In order to enhance adhesion with other layers, if necessary, the substrate 2 may be subjected to on its one side or both sides an easily adhesive treatment such as a physical or a chemical surface treatment including an oxidation method and a roughing method. Illustrative example of the oxidation method includes a corona discharge treatment, a chromium oxidation treatment, a flame treatment, a hot-air treatment, and an ozone-UV treatment; and illustrative example of the roughing method includes a sand blast method and a solvent treatment method. These surface treatments may be selected arbitrarily in accordance with the kind of the substrate; however, generally a corona discharge method is used preferably because of its effect, workability, and so forth.

In the present invention, an easily adhesive coating treatment is preferably used as a chemical surface treatment. In the easily adhesive coating treatment, a layer of a resin and the like is coated on the substrate so as to enhance the adhesion thereof, wherein the coating treatment by a polyurethane-based resin and the like may be mentioned as the example thereof. A polyurethane-based resin such as a urethane urea resin, in addition to usual urethane resins, may be used, too. The coating amount thereof is usually in the range of about 0.01 to about 0.5 g/m², or preferably in the range of 0.03 to 0.3 g/m².

The said polyurethane-based resin is preferably crosslinked; and illustrative example of the crosslinking agent includes a melamine-based crosslinking agent and an epoxy-based crosslinking agent.

In addition, as a preferable alternative embodiment, by using a transparent or a semi-transparent substrate as the substrate 2, an adhesive layer (not shown by drawing) and a bonding substrate (not shown by drawing) may be laminated on the backside of the said substrate (the opposite side of the precoat layer 3).

In the print sheet 1 of the present invention, the precoat layer 3 is formed on the substrate 2. The wetting tension of the precoat layer 3 is preferably in the range of 30 to 60 mN/m.

Meanwhile, the wetting tension is measured in accordance with JIS K6768:1999.

In the print sheet 1 of the present invention, by interposing the precoat layer 3 having the wetting tension of 30 to 60 mN/m between the substrate 2 and the dot-printed layer 4, it became possible to form the dot-printed layer 4 having a dot pattern readable with a high reading precision within the prescribed dot size (dot diameter in the range of 80 to 130 μm). In other words, by controlling the wetting tension of the precoat layer 3, it became possible to control the variance of the dot diameter and the form thereof in the dot-printed layer 4.

The wetting tension of the precoat layer 3 is preferably 30 mN/m or more, because adhesion with the dot-printed layer 4 and with the easily adhesive layer 5 can be enhanced. In addition, if it is 60 mN/m or less, the dot diameter does not exceed the upper limit thereof because the dot-printed layer 4 is not spread out in the wet state immediately after printing; and thus, this range is preferable.

The precoat layer 3 of the present invention comprises a resin composition comprising titanium oxide and at least one resin selected from a polyurethane resin and an acryl polyol resin.

The polyurethane resin used in the precoat layer 3 may be any of a thermosetting polyurethane resin and a thermoplastic polyurethane resin; however, a thermosetting polyurethane resin is preferable. This is because adhesion of an ink in the resin composition used in the precoat layer 3 with the substrate 2 can be enhanced.

As to the thermosetting polyurethane resin, any of a two liquid hardening type and a single-component liquid hardening type may be used; however, the two liquid hardening type polyurethane resin is preferable.

The two liquid hardening type polyurethane resin is a polyurethane resin comprising a polyol as a main agent and a polyisocyanate as a crosslinking agent (hardening agent), wherein polyols having two or more hydroxy groups per one molecule such as, for example, polyethylene glycol, polypropylene glycol, acryl polyol, polyester polyol, polyether polyol, polycarbonate polyol, polycaprolactone polyol, and polyurethane polyol may be used. On the other hand, polyisocyanates having two or more isocyanate groups per one molecule such as, for example, aromatic isocyanate such as 2,4-tolylene diisocyanate, xylene diisocyanate, naphthalene diisocyanate, and 4,4′-diphenylmethane diisocyanate may be used; or aliphatic (or alicyclic) isocyanate such as 1,6-hexamethylene diisocyanate, 2,2,4-trimethylhexamethylene diisocyanate, isophorone diisocyanate, hydrogenated tolylene diisocyanate, and hydrogenated diphenylmethane diisocyanate may be used. Alternatively, an adduct or an oligomer of the above-mentioned various polyisocyanates such as, for example, an adduct of tolylene diisocyanate and a trimer of tolylene diisocyanate may be used as the polyisocyanates.

The thermoplastic polyurethane resin is a copolymer formed by copolymerizing monomers by means of a urethane bond formed by condensation of a compound having an isocyanate group with a compound having a hydroxy group such as an alcohol group.

The acryl polyol resin is a polymer having a hydroxy-containing (meth)acryl monomer unit such as poly(hydroxyethyl methacrylate).

The resin composition to form the precoat layer 3 of the present invention requires to contain titanium oxide.

In order to control the wetting tension of the precoat layer 3 within the range of 30 to 60 mN/m, the oil absorption number of titanium oxide is preferably in the range of 10 to 48 mL/100-g. If the oil absorption number of titanium oxide is made lower, the wetting tension of the precoat layer 3 may be made lower; and if the oil absorption number of titanium oxide is made higher, the wetting tension of the precoat layer 3 may be made higher. Namely, the wetting tension of the precoat layer 3 may be controlled by the oil absorption number of titanium oxide.

Content of titanium oxide is preferably in the range of 40 to 90% by mass in the total resin composition to form the precoat layer 3. Content of 40% or more by mass is preferable because of a concealing effect of the substrate; and content of 90% or less by mass is preferable because the printing adaptability is excellent, and in addition, titanium oxide is stably supported in the polyurethane resin of the precoat layer after the printed layer is formed thereby affording sufficient strength as the layer. Content of titanium oxide is more preferably in the range of 45 to 90% by mass in the total resin composition to form the precoat layer 3. Content of 45% or more by mass gives a further sufficient concealing effect. From the above view points, the content thereof is still more preferably in the range of 45 to 85% by mass.

Thickness of the precoat layer 3 is not particularly restricted, though it is preferably in the range of 1 to 20 Thickness of 1 μm or more is preferable because of concealing effect of the substrate; and thickness of 20 μm or less is preferable because of advantageous effects of printing adaptability, manufacturing cost, and workability. From the above view points, thickness of the precoat layer 3 is more preferably in the range of 1 to 10 μm.

Coating method of the precoat layer 3 is not particularly restricted; and thus, a heretofore known method such as a gravure coating method, a bar coating method, a roll coating method, a reverse roll coating method, a comma coating method, and the like may be used.

If thickness thereof is 10 μm or less, blocking may be suppressed during the time of manufacturing of a decorative sheet, and in addition, there is no such a trouble that a printing ink is transferred to a guide roll when a printed surface is contacted to a guide roll to lead a printed paper.

The print sheet 1 of the present invention has the dot-printed layer 4 formed on the precoat layer 3, wherein the dot-printed layer is formed of a pattern having regularity. Material of the said pattern is not particularly restricted provided that the material can be detected by an input terminal as to the contrast between the pattern-formed part and the pattern non-formed part; and therefore, a material usually used as a colorant in a decorative sheet and the like may be used.

Specific example of the colorant includes inorganic pigments such as carbon black (charcoal), iron black, titanium white, antimony white, yellow iron oxide, chrome yellow, titanium yellow, red iron oxide, chrome vermilion, cadmium yellow, cadmium red, ferrocyanide, ultramarine, and cobalt blue; organic pigments or dyes such as quinacridone red, isoindolinone yellow, phthalocyanine blue, and phthalocyanine green; metal pigments in the scale form of a foil piece such as aluminum and brass; and pearl-like glossy pigments in the scale form of a foil piece such as mica covered with titanium dioxide and basic lead carbonate. These may be used solely or as a mixture of them.

As to the ink used to form the dot-printed layer 4, the above-mentioned colorant containing a binder may be used after it is arbitrarily mixed with an extender pigment, a solvent, a stabilizer, a plasticizer, a catalyst, a hardening agent, and the like. There is no particular restriction as to the binder, while illustrative example thereof includes a polyurethane-based resin, a vinyl chloride/vinyl acetate-based copolymer resin, a vinyl chloride/vinyl acetate/acryl-based copolymer resin, a vinyl chloride/acryl-based copolymer resin, a chlorinated polypropylene-based resin, an acryl-based resin, a polyester-based resin, a polyamide-based resin, a butyral-based resin, a polystyrene-based resin, a nitrocellulose-based resin, and a cellulose acetate-based resin; these may be used solely or as an arbitrary mixture of two or more of them.

The printing method for the dot-printed layer 4 is not particularly restricted; and thus, heretofore known methods may be used. Illustrative example thereof includes a gravure printing method, an off-set printing method, a flexographic printing method, a mimeographic printing method, and an ink jet printing method. Among them, the gravure printing method is preferable because of fast printing speed and high productivity. According to the present invention, printing can be done satisfactorily by the gravure printing method, too.

The pattern having a regularity in the dot-printed layer 4 is formed of, for example, many independent dots and is laid out dispersively on the substrate 2 (hereinafter, this is sometimes referred to as “dot pattern”). These dots are laid out according to a prescribed regularity; and the location thereof on the print sheet can be judged from the lay-out relation. The dot pattern like this is specifically exemplified by a so-called Anoto pattern specified by Anoto Group AB.

The dot pattern having a regularity in the present invention may be exemplified by such as, for example, plural dot forms are determined, and whereby the dots having these plural forms laid out within a prescribed area in a plane are combined to form a pattern, as shown in Patent Document 1; widths of the lines laid out in matrix are changed, and whereby the sizes of the overlapping parts of the lines within a prescribed area are combined to form a pattern; the values in the x- and y-axes are directly combined with the horizontal and vertical sizes of the dot; and especially simple and preferable one is a method wherein reference points are set up in parallel in vertical and horizontal directions with the same distance, and the dots that are displaced from side to side and up and down from these reference points are arranged, thereby utilizing the relative location relation from the reference points of these dots. In this method, the size of the dot can be made small and constant; and thus, this method is advantageous to make resolution of the input device higher.

There is no particular restriction as to the dot form in the dot pattern provided that it is readily distinguishable from that of the neighboring dot; and the form thereof is usually circular, oval, polygonal, or the like in the planar view. There is no particular restriction as to the dot's steric figure, either; and a rough disk-like figure, a semi-spherical figure, a concave figure, a polyhedral figure, and the like may be exemplified for it. Among them, a circular form in the planar view is preferable.

Next, in the print sheet of the present invention, in order to protect the dot-printed layer 4 and to enhance the adhesion between the surface protective layer 6 and the layer thereunder, an easily adhesive layer 5 is formed. By enhancing the adhesion strength, removal of the dots due to surface friction may be prevented from occurring even if a water-based ink or a one-component hardenable ink, which are poor in adhesion with the substrate, is used in the dot pattern.

There is no particular restriction as to the resin composition to constitute the easily adhesive layer 5; however, in order to enhance the adhesion as mentioned above and in view of readability of the dots in the final product, a two liquid hardening type resin which is colorless or a semitransparent milky white is preferable, though a two liquid hardening type polyurethane resin is especially preferable. As to the two liquid hardening type polyurethane resin, those used in the afore-mentioned precoat layer 3 may be used preferably.

In the easily adhesive layer 5, in order to prevent discoloration of the sheet from occurring during passage of time, a weatherability enhancer to enhance the weatherability thereof may be added provided that the addition thereof does not impair the sheet performance (this will be discussed later); and the weatherability enhancer that can be used may be exemplified by a UV absorber and a light stabilizer. As to the UV absorber, any of an inorganic and an organic UV absorber may be used; and the inorganic UV absorber that can be preferably used may be exemplified by titanium dioxide, a cerium oxide, and zinc oxide, with the respective average particle diameters thereof being in the range of about 5 to about 120 nm. As to the organic UV absorber, a benzotriazole-based UV absorber may be exemplified; and specific example thereof includes 2-(2-hydroxy-5-methylphenyl)benzotriazole, 2-(2-hydroxy-3,5-di-tert-amylphenyl)benzotriazole, and an ester of polyethylene glycol with 3-[3-(benzotriazole-2-yl)-5-tert-butyl-4-hydroxyphenyl]propionic acid. As to the light stabilizer, a hindered amine-based light stabilizer may be exemplified; and specific example thereof includes bis(1,2,2,6,6-pentamethyl-4-piperidyl)2-(3,5-di-tert-butyl-4-hydroxybenzyl)-2′-n-butyl malonate, bis(1,2,2,6,6-pentamethyl-4-piperidyl)sebacate, and tetrakis(2,2,6,6-tetramethyl-4-piperidyl)-1,2,3,4-butanetetracarboxylate.

The blending amount of the weatherability enhancer is in the range of about 1 to about 50% by mass, preferably in the range of 3 to 40% by mass, or more preferably in the range of 5 to 25% by mass in the totality of the resin composition to constitute the easily adhesive layer 5.

There is no particular restriction as to the thickness of the easily adhesive layer 5; however, the thickness thereof is preferably in the range of 1 to 10 μm. Thickness of 1 μm or more is advantageous in view of protection of the dot-printed layer 4 against surface friction; on the other hand, if thickness thereof is 10 μm or less, an adverse effect to the dot pattern due to the conceal action of an inorganic additive contained in the easily adhesive layer or due to the refractive index of the resin that constitutes the easily adhesive layer can be suppressed so that recognition of the electronic pen with regard to the location information may not be impaired. From the above view points, thickness of the easily adhesive layer 5 is more preferably in the range of 1 to 5 μm.

Coating method of the easily adhesive layer 5 is not particularly restricted; and thus, a heretofore known method such as a gravure coating method, a bar coating method, a roll coating method, a reverse roll coating method, a comma coating method, and the like may be used.

The surface protective layer 6 is constituted by a crosslink-hardened material of a hardening resin composition. As to the hardening resin composition, a thermosetting resin composition may be used; however, a resin composition hardenable by an ionizing radiation beam is preferable, while a resin composition hardenable by an electron beam is especially preferable.

The thermosetting resin used in the thermosetting resin composition to form the surface protective layer 6 may be exemplified by a polyester resin, an epoxy resin, a thermosetting polyurethane resin, an aminoalkyd resin, a melamine resin, a guanamine resin, a urea resin, and a thermosetting acryl resin. Among them, a thermosetting polyurethane resin is preferably used.

In the present invention, the resin hardenable by an ionizing radiation beam means a resin that is crosslink-hardenable by irradiating, among electromagnetic beams or charged particle beams, a beam having an energy quantum capable of crosslinking and polymerizing the molecules, namely, it means a resin that is crosslink-hardenable by irradiating a UV beam or an electron beam. Specifically, a resin arbitrarily selected from a polymerizable monomer, a polymerizable oligomer, and a prepolymer which are usually used as a resin hardenable by an ionizing radiation beam may be used.

Typically, as to the polymerizable monomer, a (meth)acrylate-type monomer having a radical polymerizable unsaturated group in its molecular structure is preferable; especially, a polyfunctional (meth)acrylate is preferable. Meanwhile, “meth(acrylate)” herein means “acrylate or methacrylate”; and the same is applied for other analogues thereof. As to the polyfunctional (meth)acrylate, there is no particular restriction provided that the (meth)acrylate has two or more ethylenic unsaturated bonds in a molecule. These polyfunctional (meth)acrylates may be used solely or as a combination of two or more of them.

The polymerizable oligomer may be exemplified by an oligomer having a radical polymerizable unsaturated group in its molecular structure, such as for example, an epoxy (meth)acrylate type, a urethane (meth)acrylate type, a polyester (meth)acrylate type, and a polyether (meth)acrylate type. Here, the oligomer of an epoxy (meth)acrylate type may be obtained by, for example, reacting a (meth)acrylic acid for esterification with an oxirane ring of a bisphenol-type epoxy resin or a novolak-type epoxy resin, these resins having comparatively low molecular weights. A carboxy-modified epoxy (meth)acrylate oligomer obtained by partially modifying the oligomer of an epoxy (meth)acrylate type with a dibasic carboxylic acid anhydride may also be used. The oligomer of a urethane (meth)acrylate type may be obtained by, for example, esterifying a (meth)acrylic acid with a polyurethane oligomer obtained by reacting a polyether polyol or a polyester polyol with a polyisocyanate. The oligomer of a polyester (meth)acrylate type may be obtained by, for example, esterifying a (meth)acrylic acid with the OH group of a polyester oligomer having OH groups in its both terminals which is obtained by condensation of a polyvalent carboxylic acid with a polyvalent alcohol, or by esterifying a (meth)acrylic acid with the terminal OH group of an oligomer obtained by adding an alkylene oxide to a polyvalent carboxylic acid. The oligomer of a polyether (meth)acrylate type may be obtained by, for example, esterifying a (meth)acrylic acid with the OH group of a polyether polyol.

In addition to the foregoing examples, the polymerizable oligomer may be exemplified by a highly hydrophobic oligomer of a polybutadiene (meth)acrylate type having a (meth)acrylate group at the side chain of a polybutadiene oligomer, an oligomer of a silicone (meth)acrylate type which has a polysiloxane bond in its main chain, an oligomer of an aminoplast resin (meth)acrylate type which is obtained by modifying an aminoplast resin having many reactive groups in its small molecule, and an oligomer having an cationic polymerizable functional group in a molecule of a novolak-type epoxy resin, a bisphenol-type epoxy resin, an aliphatic vinyl ether, an aromatic vinyl ether, and the like.

In the present invention, in order to decrease viscosity of the above-mentioned polyfunctional (meth)acrylate or for other reason, a monofunctional (meth)acrylate may be arbitrarily used together with the polyfunctional (meth)acrylate within the range not impairing the object of the present invention. These monofunctional (meth)acrylates may be used solely or as a combination of two or more of them.

The number-average molecular weight (polystyrene-equivalent number-average molecular weight measured by GPC) of the resin hardenable by an ionizing radiation beam is preferably in the range of 1,000 to 10,000, or more preferably in the range of 2,000 to 10,000. If the number-average molecular weight is within the foregoing range, the coating composition is afforded with excellent workability and suitable thixotrophy so that the surface protective layer may be formed readily.

If a UV-hardening resin composition is used as the resin hardenable by an ionizing radiation beam, it is preferable that a photo-polymerization initiator be added in the range of about 0.1 to about 5 parts by mass per 100 parts by mass of the resin composition. There is no particular restriction as to the photo-polymerization initiator; and thus, any initiator that has been conventionally used may be arbitrarily chosen.

In the present invention, the resin composition hardenable by an electron beam is especially preferably used as the hardening resin composition. This is because the resin composition hardenable by an electron beam can be used without a solvent so that this is preferable from environmental and health view points; and in addition, this composition does not require a photo-polymerization initiator, and yet has stable hardening characteristics. There is no particular restriction as to the coating method of the hardening resin composition; and thus, a heretofore known method such as a gravure coating method, a bar coating method, a roll coating method, a reverse roll coating method, a comma coating method, and the like may be used. The coating amount thereof is preferably in the range of 1 to 20 μm (thickness after hardened).

The hardening resin composition used for the surface protective layer in the present invention may contain a filler. Material and content of the filler is determined in relation with the substrate to be used, the resin composition to constitute the easily adhesive layer, and so forth, wherein these are selected such that the 60 degree gloss value on the surface of the print sheet of the present invention may be preferably in the range of 10 to 75 (both ends inclusive), or more preferably in the range of 25 to 75 (both ends inclusive).

There is no particular restriction as to material of the filler provided that the 60 degree gloss value is within this range; and thus, any of an inorganic filler and an organic filler may be used.

Illustrative example of the inorganic filler includes calcium carbonate, magnesium carbonate, fly ash, dehydrated waste mad, natural silica, synthetic silica, kaolin, clay, calcium oxide, magnesium oxide, titanium oxide, zinc oxide, barium sulfate, calcium hydroxide, aluminum hydroxide, alumina, magnesium hydroxide, talc, mica, hydrotalcite, aluminum silicate, magnesium silicate, calcium silicate, burnt talc, wollastonite, potassium titanate, magnesium sulfate, calcium sulfate, magnesium phosphate, sepiolite, xonolite, aluminum borate, silica balloon, glass flake, glass balloon, silica, iron slag, copper, iron, iron oxide, carbon black, sendust, alnico magnet, magnet powders of various ferrites, cement, glass powders, silica sand, antimony trioxide, magnesium oxysulfate, hydrated aluminum, hydrated gypsum, and alum.

Meanwhile, these inorganic fillers may be used solely or as a mixture of two or more of them.

Illustrative example of the organic filler includes polyolefin resins such as polyethylene and polypropylene; a fluorinated resin; a styrenic resin; an epoxy-type resin; a melamine-type resin; a urea-type resin, an acryl-type resin; a phenol-type resin; a polyimide-type resin; a polyamide-type resin; and a polyester-type resin. Alternatively, copolymers of the above-mentioned resins may also be used. Among them, in view of the performance as a white board, or more specifically, in order to prevent contamination of the filler's color by a marker from occurring upon writing and erasing, an organic filler formed by a urea-type resin is preferable.

The organic filler formed of the urea-type resin is an organic filler comprising only a urea resin belonging to a thermosetting resin obtained by polymerization reaction of urea with formaldehyde, or is an organic filler formed of a resin composition comprising a mixture of a urea resin with other resin or with a filler. The filler like this can be used suitably in the present invention.

In addition, in view of stability of the filler after hardening of the hardening resin, it is preferable that the filler have the chemical composition having the reactive group in the hardening resin.

Further, in order to obtain satisfactory functions as a projection screen, it is preferable that the organic filler be amorphous and have a sufficient oil absorption number.

Meanwhile, these organic fillers may be used solely or as a combination of two or more of them.

As mentioned above, content of the filler in the hardening resin composition is selected such that the 60 degree gloss value on the surface of the print sheet may become preferably in the range of 10 to 75 (both ends inclusive), or more preferably in the range of 25 to 75 (both ends inclusive), though the optimum range thereof is different depending on the material to be used and the like. In general, there is a tendency that the 60 degree gloss value becomes lower when content of the filler is increased while the gloss value becomes higher when the content thereof is decreased.

More specifically, the optimum amount of the filler is preferably in the range of 0.5 or more parts by mass to less than 12 parts by mass per 100 parts by mass of the hardening resin; especially in the case of the organic filler, the preferable amount thereof is in the range of 0.5 to 11 parts by mass per 100 parts by mass of the hardening resin.

The average particle diameter of the filler is selected such that the 60 degree gloss value on the surface of the print sheet may become preferably in the range of 10 to 75 (both ends inclusive), or more preferably in the range of 25 to 75 (both ends inclusive); and thus, generally the diameter thereof is preferably in the range of 0.5 to 10 μm. If the average particle diameter thereof is 0.5 μm or more, sufficient matting effect of the surface protective layer may be obtained so that the function as the projection screen can be fully realized. On the other hand, the diameter thereof is 10 μm or less, roughness of the surface on the surface protective layer upon forming thereof may be made smooth; and thus, writing by a white board marker can be made smoothly, and in addition, the mark can be erased by an eraser without its trace. From the above view points, the average particle diameter of the filler is more preferably in the range of 1 to 7 μm.

If so desired, the print sheet 1 of the present invention may be laminated with a bonding substrate (not shown by drawing) on the backside of the substrate 2 (the opposite side of the dot-printed layer 4) via an adhesive layer (not shown by drawing).

The adhesive used in the adhesive layer may be arbitrarily selected from those that are heretofore known or commercially available in accordance with the component to constitute the substrate 2, the bonding substrate, and the like. Illustrative example thereof includes thermosetting resins such as a polyester-type resin, a polyurethane-type resin, a polyester-urethane-type resin, and an epoxy-type resin, in addition to polyolefin resins such as polyethylene and polypropylene. These resins may be used also in the state of an emulsion. Among them, in view of heat resistance, an adhesive of the urethane-type resin is preferable. The preferable adhesive of the urethane-type resin may be exemplified by a two liquid hardening type polyurethane resin comprising a polyol as a main agent and an isocyanate as a crosslinking agent (hardening agent).

Adhesion may be done by a heretofore known method in accordance with the kind of the adhesive to be used. The substrate 2 and the bonding substrate may be laminated by a dry laminating method after applying an adhesive or by a hot press method using an adhesive that is adherable by hot press.

Thickness of the adhesive layer is usually in the range of about 0.1 to about 30 μm, though depending on the kind and the like of the adhesive to be used.

As to the bonding substrate, those having preferably 7 or less, or more preferably 5 or less as the 60 degree gloss value on the surface of the side of the substrate 2 may be used. By so doing, even in the case that filler content in the surface protective layer 6 is comparatively small, the 60 degree gloss value on the surface in the entire pattern-print sheet may be made in the range of 10 to 75 (both ends inclusive), or even in the range of 25 to 75 (both ends inclusive), as mentioned above.

As to the bonding substrate, the same material as the substrate 2 as mentioned before may be used.

The bonding substrate colored by containing a colorant or the like may be used. As to the colorant used in the bonding substrate, there is no particular restriction provided that the input terminal can recognize the contrast between the pattern-formed part of the dot-printed layer 4 and the bonding substrate; and thus, a colorant in accordance with the wavelength that can be read by the input terminal may be used. Illustrative example of the colorant like this includes inorganic pigments such as calcium carbonate, titanium oxide, mica, talc, antimony white, yellow iron oxide, chrome yellow, titanium yellow, red iron oxide, chrome vermilion, cadmium yellow, cadmium red, ferrocyanide, ultramarine, and cobalt blue; organic pigments or dyes such as quinacridone red, isoindolinone yellow, phthalocyanine blue, and phthalocyanine green; metal pigments in the scale form of a foil piece such as aluminum and brass; and pearl-like glossy pigments in the scale form of a foil piece such as mica covered with titanium dioxide and basic lead carbonate. Similarly to the substrate 2, white colorants such as calcium carbonate, titanium oxide, mica, talc, and the like are preferable.

The print sheet of the present invention may have an arbitrary figure pattern by further arranging a figure pattern layer (not shown by drawing).

The figure pattern layer is formed preferably between the dot-printed layer 4 and the easily adhesive layer 5, the backsides of the substrate 2 (rear surface of the substrate 2, between the substrate 2 and the adhesive layer, or between the adhesive layer and the bonding substrate), or the like, because reproducibility of the pattern is not impaired upon forming the dot-printed layer 4.

As to the method for forming the figure pattern layer, specifically a method that various figures are printed in more than one place on any of the dot-printed layer 4 and the rear side of the substrate 2 by using an ink and a printing machine may be mentioned.

As to the colorant used for forming the figure pattern layer, there is no particular restriction provided that the input terminal can recognize the contrast between the pattern-formed part of the dot-printed layer 4 and the bonding substrate; and thus, the colorant may be selected in accordance with the detection light of the input terminal, the colorant to form the dot-printed layer 4, the colorant contained in the substrate 2 and the bonding substrate, and the like. Illustrative example the colorant like this includes inorganic pigments such as titanium white, antimony white, yellow iron oxide, chrome yellow, titanium yellow, red iron oxide, chrome vermilion, cadmium yellow, cadmium red, ferrocyanide, ultramarine, and cobalt blue; organic pigments or dyes such as quinacridone red, isoindolinone yellow, phthalocyanine blue, and phthalocyanine green; metal pigments in the scale form of a foil piece such as aluminum and brass; and pearl-like glossy pigments in the scale form of a foil piece such as mica covered with titanium dioxide and basic lead carbonate.

It is preferable that the print sheet of the present invention have the pencil hardness of 2B or higher in its surface. If the pencil hardness thereof is 2B or higher, not only excellent scratch resistance may be obtained, but also it is difficult to form a concavity by a pencil pressure when writing is done by a hard pen tip such as a pen tip of an electronic pen, the input terminal. In view of the above-mentioned, the pencil hardness thereof is more preferably B or higher.

As to the input terminal usable in the present invention, there is no particular restriction provided that it can recognize the contrast between the pattern-formed part and the pattern non-formed part of the dot-printed layer 4; and thus, it is allowed if a heretofore known sensor is arranged therein.

The location information is calculated from the continuously sensed data that are read by the input terminal; and then, this information is combined with the time information thereby providing it as the input trajectory data that can be dealt with by an information processing device. Meanwhile, these devices are not particularly restricted provided that they are provided with the members such as a processor, a memory, a communication interface, a battery, and so forth.

The processing device for the read data may be stored in the input terminal or in an external information processing device.

### EXAMPLES

Hereunder, the present invention will be explained in more detail by Examples; however, the present invention is not limited at all by these Examples.

### Evaluation Methods:

(1) Oil Absorption Number of Titanium Oxide (mL/100 g)

Boiled linseed oil was added in drops to 2 g of titanium oxide placed on a glass plate with well mixing them by using a metallic spatula; and then, the amount (unit: g) of the boiled linseed oil (in terms of 100 g of titanium oxide) that is added until a mixture of boiled linseed oil and titanium oxide becomes a paste form with a certain shape is taken.

### (2) Wetting Tension of the Precoat Layer 3

This was measured in accordance with JIS K6768:1999.

### (3) Dot Diameter

By using an optical microscope (magnification of 100-folds), five dots in the observed area were arbitrarily chosen, and diameters of the respective dots in the planar view were measured; and then, the dot diameter was obtained from the arithmetic average thereof. The allowable dot diameter is in the range of 80 to 130 μm.

### (4) Judgment of the Dot Pattern Reading Performance (This is Abbreviated as “APA” in Table 1 and Table 2)

With regard to the print sheet obtained by each of Examples and Comparative Examples, whether the coordinate information of the dot pattern can be read or not was confirmed by using the Anoto pattern detection device APA DMS910IR (manufactured by TECHKON Co., Ltd.) and the dedicated software Anoto Pattern Analyzer. The judgment was done in accordance with following criteria.
1: The coordinate information can be read without problem by the foregoing dedicated reading device (the dot diameter is in the range of 90 to 120 μm).
2: The dot diameter is near the upper limit and the lower limit of the reading range (in the range of 80 to 130 μm) of the forgoing dedicated reading device (the dot diameter is in the range of 80 to 90 μm or in the range of 120 to 130 μm).
3: There are some parts whose coordinate information cannot be read by the foregoing dedicated reading device.
4: The coordinate information cannot be read by the foregoing dedicated reading device.

### (5) 60 Degree Gloss Value

The gloss of the print sheet surface (60 degree gloss value) was measured with the incident light angle of 60° by using the gloss meter Micro-TRI-Gloss (manufactured by BYK-Gardner GmbH).

### (6) Projector Projection Character

Projection was made by using the LV 7365 projector (manufactured by Canon Inc.) with the condition that the print sheet was adhered on a vertical plane with no wrinkles; and the evaluation was made with regard to the hot spot (light ball by an irradiating light) according to the following criteria. Acceptance was given to the following 1 to 3, while following 4 was judged to be unacceptable.
1: A hot spot was not confirmed.
2: A hot spot not glaring but fuzzy was observed
3: A hot spot was confirmed as a circular light with slight glare.
4: A hot spot was confirmed as a clear circular light with strong glare.

### (7) Mark-Erasing Ability

After written by Knockle White Board Marker (red) (manufactured by Pentel Co., Ltd.), the written mark was dried at room temperature for 1 minute and then erased by MagX Magnet Eraser (merchant code of MMRE J (made of a felt), manufactured by MagX Co., Ltd.) with the load of 500 g; and then, after the mark was erased, the appearance was evaluated in accordance with the following criteria. Acceptance was given to the following 1 to 4, while following 5 was judged to be unacceptable.
1: A mark could be readily erased by one-way erase.
2: A mark could be erased by one reciprocal erase.
3: A mark could be erased by plural reciprocal erases.
4: A residual marked color was confirmed faintly after 5 reciprocal erases.
5: A marked color was clearly confirmed after 5 reciprocal erases.

### Example 1

As shown in Table 1, on surface of the white PET film having thickness of 125 μm (U2 L92W, manufactured by Teijin Dupont Films Japan Ltd.) was applied a white ink having titanium oxide as a pigment and a two liquid hardening type polyurethane resin as a binder so as to obtain a precoat layer having the film thickness of 5 μm.

Then, on surface of the precoat layer was laminated a dot-printed layer having a dot pattern having regularity by a gravure coater method by using a black ink containing carbon black as a pigment and a vinyl chloride/vinyl acetate/acryl-type copolymer resin as a binder.

Then, a two liquid hardening type polyurethane resin was applied by a gravure coater method so as to obtain an easily adhesive layer having the film thickness of 2 μm (in dry state).

Thereafter, a resin composition hardenable by an electron beam comprising 100 parts by mass of a resin hardenable by an electron beam, this resin being mainly comprised of an acrylate resin hardenable by an electron beam and a polyfunctional monomer (WBW Hard (average functional number of 4.0), manufactured by DIC Graphics Corp.), 3 parts by mass of silicone acrylate prepolymer (WBW Silicone Additive, manufactured by DIC Graphics Corp.), and 5 parts by mass of an organic filler comprising a urea type resin having average particle diameter of 5 μm was applied thereon by a gravure direct coater method so as to laminate a surface protective layer (unhardened) with the film thickness of 3.0 μm (in dry state). After this application, an electron beam was irradiated with the acceleration voltage of 165 kV and the dose amount of 50 kGy (5 Mrad) to harden the resin composition hardenable by an electron beam to obtain a surface protective layer, thereby obtaining a print sheet.

The print sheet thus obtained was evaluated by the afore-mentioned evaluation method (4); and the result thereof is shown in Table 1.

### Examples 2 to 5 and Comparative Example 1

The procedure of Example 1 was repeated, except that the precoat layer was changed as shown in Table 1, to obtain a print sheet. The evaluation results obtained by the same evaluation method as Example 1 are shown in Table 1.

Meanwhile, the two liquid hardening type polyurethane resin was used also in Examples 2 to 5 as the polyurethane resin used for the precoat layer.

TABLE 1

| | | | Example | | | | | Comparative |
|---|---|---|---|---|---|---|---|---|
| | | | 1 | 2 | 3 | 4 | 5 | Example 6 |
| Precoat layer | Resin | Polyurethane resin (% by mass) | 11.5 | 12 | 11 | 12 | 17 | None |
| | component | Cellulose (% by mass) | — | — | — | 1 | — | |
| | Pigment | Titanium oxide (% by mass) | 55 | 50 | 54 | 47.5 | 38 | |
| | | Extender silica pigment (% by mass) | — | — | — | — | 1 | |

| | | | | | |
|---|---|---|---|---|---|
| Oil absorption number of titanium | 17 | 25 | 20 | 40 | 50 |
| oxide (mL/100 g) | | | | | |
| Wetting tension of precoat | 35 | 42 | 43 | 54 | 64 |
| layer (dyne/cm) | | | | | |

| | | | | | | | |
|---|---|---|---|---|---|---|---|
| APA Evaluation | Dot diameter (average value of 5 dots) | 108 | 102 | 114 | 127 | 130 | 131 |
| | (μm) | | | | | | |
| | Judgment | 1 | 1 | 1 | 2 | 3 | 4 |

### Examples 6 to 11

The procedure of Example 1 was repeated, except that content of the organic filler formed of the urethane type resin (average particle diameter of 3.0 μm) in the surface protective layer was changed as shown in Table 2, to obtain a print sheet. The evaluation results obtained by the same evaluation method as Example 1, the 60 degree gloss value obtained by the afore-mentioned method, the projector projection character, and the mark-erasing ability are shown in Table 2.

Meanwhile, the two liquid hardening type polyurethane resin was used also in Examples 6 to 11 as the polyurethane resin used for the precoat layer.

TABLE 2

| | | | Examples | | | | | |
|---|---|---|---|---|---|---|---|---|
| | | | 6 | 7 | 8 | 9 | 10 | 11 |
| Precoat layer | Resin | Polyurethane resin (% by mass) | 11.5 | 11.5 | 11.5 | 11.5 | 11.5 | 11.5 |
| | component | Cellulose (% by mass) | — | — | — | — | — | — |
| | Pigment | Titanium oxide (% by mass) | 55 | 55 | 55 | 55 | 55 | 55 |
| | | Extender silica pigment (% by mass) | — | — | — | — | — | — |
| | Oil absorption number of titanium oxide (mL/100-g) | | 17 | 17 | 17 | 17 | 17 | 17 |
| | Wetting tension of precoat layer (dyne/cm) | | 35 | 35 | 35 | 35 | 35 | 35 |
| Surface protective layer | Resin | Resin hardenable by electron beam (parts by mass) | 100 | 100 | 100 | 100 | 100 | 100 |
| | composition | Silicone acrylate prepolymer (parts by mass) | 3 | 3 | 3 | 3 | 3 | 3 |
| | hardenable by | Organic filler comprising urea resin (average | 20 | 15 | 12 | 6 | 1.5 | 0.5 |
| | electron beam | particle diameter: 5 μm) (parts by mass) | | | | | | |

| | | | | | | |
|---|---|---|---|---|---|---|
| Layer thickness (μm) | 3.0 | 3.0 | 3.0 | 3.0 | 3.0 | 3.0 |

| | | | | | | | |
|---|---|---|---|---|---|---|---|
| APA Evaluation | Dot diameter (average value of 5 dots) (μm) | 108 | 108 | 108 | 108 | 108 | 108 |
| | Judgment | 1 | 1 | 1 | 1 | 1 | 1 |

| | | | | | | |
|---|---|---|---|---|---|---|
| 60 degree gloss value | 7 | 10 | 15 | 35 | 65 | 80 |
| Projector projection character | 1 | 1 | 2 | 2 | 3 | 4 |
| Mark-erasing ability | 5 | 4 | 3 | 2 | 1 | 1 |

### INDUSTRIAL APPLICABILITY

According to the print sheet of the present invention, provided is a projection screen having: a function to project the data of words and figures through a projector or the like, while writing can be done thereon; a function to take-in the said written information in real-time as a highly precise digital information, which can be projected on a projection screen; and at the same time, a function to be used as a white board.

Alternatively, in the actual use thereof, a plastic film, a wooden plyboard, a steel plate, a magnet sheet, a detachable adhesive sheet, or the like may be adhered on the back side of the print sheet of the present invention. By combining with a plastic film, a wooden plyboard, a steel plate, or the like, this print sheet may be used as a movable white board, a partition wall, and a part of a construction material such as a wall, which have been commonly used.

If a magnet sheet or a detachable adhesive sheet is adhered to the print sheet, the performances as mentioned above may be afforded to a black board and a wall that have already been installed; and in addition, this can be readily carried by a manpower because it is a sheet form, so that this can be used without restriction of a space.

Furthermore, the print sheet of the present invention may also be used as a white board sheet dually as a projection sheet, not as the sheet for an electronic pen.

### REFERENCE NUMERALS

1: Print sheet
2: Substrate
3: Precoat layer
4: Dot-printed layer
5: Easily adhesive layer
6: Surface protective layer

1. A print sheet comprising, on a substrate, sequentially a precoat layer, a dot-printed layer, an easily adhesive layer, and a surface protective layer comprising a crosslink-hardened material of a hardening resin composition, wherein the precoat layer comprises a resin composition comprising titanium oxide and at least one resin selected from a polyurethane resin and an acryl polyol resin.

2. The print sheet according to claim 1, wherein wetting tension of the precoat layer is in the range of 30 to 60 mN/m.

3. The print sheet according to claim 1, wherein oil absorption number of the titanium oxide is in the range of 10 to 48 mL/100-g.

4. The print sheet according to claim 1, wherein 60 degree gloss value thereof is in the range of 10 to 75.

5. The print sheet according to claim 1, wherein the easily adhesive layer comprises a hardened material of a two liquid hardening type polyurethane resin.

6. The print sheet according to claim 1, wherein the hardening resin composition contains a filler in the range of 0.5 or more by mass to less than 12 parts by mass per 100 parts by mass of a hardening resin.

7. A multifunctional projection screen using the print sheet according to claim 1.
